(19) United States
(12) Patent Application Publication
(10) Pub. No.: US 2026/0160220 A1
(43) Pub. Date: Jun. 11, 2026

(54) PNEUMATIC COLLAPSIBLE EJECTORS SUPPLY SYSTEM FOR AIRCRAFT PROPULSION

(71) Applicant: JETOPTERA, INC., Edmonds, WA (US)

(72) Inventor: Andrei Evulet, Edmonds, WA (US)

(73) Assignee: JETOPTERA, INC., Edmonds, WA (US)

(21) Appl. No.: 18/981,423

(22) PCT Filed: Jun. 23, 2023
(86) PCT No.: PCT/US2023/026081

§ 371 Date: Dec. 13, 2024

Related U.S. Application Data
(60) Provisional application No. 63/355,043, filed on Jun. 23, 2022.

(51) Int. Cl. F02K 1/36; B64C 29/00; B64D 27/18

(52) U.S. Cl. CPC F02K 1/36; B64C 29/00; B64D 27/18

(57) ABSTRACT

A propulsion system includes at least one conduit, the conduit configured to carry distribute motive fluid, the conduit further configured to collapse when not supplied with motive fluid from a compressor and inflate when supplied with motive fluid from a compressor, and at least one ejector in fluid communication with the at least one conduit, wherein the compressor supplies compressed air to the at least one ejector for producing thrust, and wherein the at least one ejector, when not in use, is retractable into a volume of an airfoil streamlining the outside of said airfoil.

### PRIORITY CLAIM

This application is a national stage entry from PCT Application No. PCT/US 2023/026081 filed Feb. 8, 2024, which claims priority from U.S. Provisional Patent Application Ser. No. 63/355,043 filed 23 Jun. 2022, the contents of which are hereby incorporated by reference as if fully set forth herein.

### COPYRIGHT NOTICE

This disclosure is protected under United States and/or International Copyright Laws.© 2023 JETOPTERA, INC., All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

One of the biggest limitations in Vertical Take-Off and Landing (VTOL) Aircraft is the forward speed these aircraft are capable of. Rotary wing aircraft are particularly efficient in using propellers and rotors to produce a very large hovering efficiency, defined as the amount of vertical force produced (in pound-force or Newton) per unit of power used (Horse Power or Watts).

Helicopters perform well in this category, being able to hover and take off vertically very efficient manner, with hovering efficiencies in the range of 5-12 lbf/hp (or 3-7.5 kg/kW). However, their forward speed is extremely limited compared to other aircraft due to the rotor limitations in forward speed, developing losses due to transition to potentially supersonic flows over the advancing blade tip while the retreating blade is well below supersonic local speeds.

To push the limit of forward speed, some manufacturers have introduced the compound helicopter, which uses dedicated fans or rotors to push forward the helicopter, while the rotor may only be used for vertical lift. However, even this approach has severe limitations and the fastest compound helicopter is not capable of more than 250 knots forward speed, and that at high altitudes only.

To overcome this, rotor wing aircraft manufacturers have introduced the tilt-rotor. The tilt rotor has the advantage of minimizing the weight of the powerplant needed to push the aircraft forward at high speeds while also performing the vertical flight propulsion function. It is however, complex and has weaknesses in controls and synchronization of the rotors. The maximum forward speed that a tilt rotor can perform is 320 knots at very high altitudes and not faster than 250 knots at sea level.

It is desired to have a vertical take-off and landing aircraft that can push the limits of forward speed.

### BRIEF DESCRIPTION OF THE DRAWING FIGURES

FIG. 1 illustrates ejectors in a deployed position and conduit inflated according to an embodiment; and

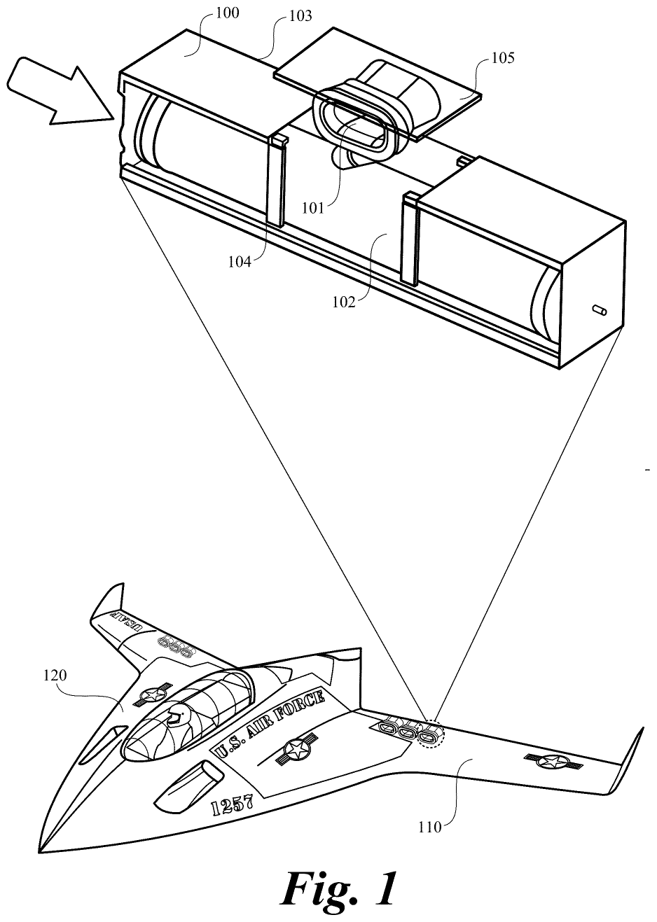

FIG. 2 illustrates ejectors in a retracted position and conduit deflated according to an embodiment.

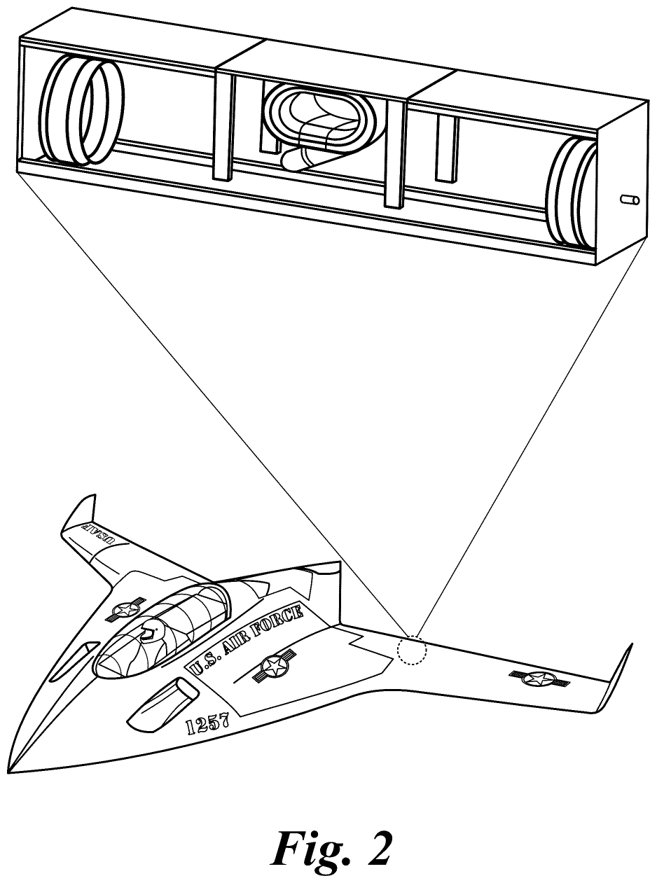

### DETAILED DESCRIPTION

An embodiment of the invention applies to both vertical take-off and landing aircraft as well as short and conventional take-off and landing aircraft.

The Fluidic Propulsive System (FPS) is such a propulsion system that can be integrated to a wing of an aircraft and become integral to the wing. In addition to the ability to employ these FPS ejectors as a Boundary Layer Control (BLC) system and augment lift, the approach can also allow the wing supporting these thrusters, which may be non-round in shape, to have a triple stall margin, (i.e., able to operate at higher angles of attack), where a clean wing would otherwise stall via separation of the boundary layer on the suction side.

Accelerating in level flight to higher speeds remained a challenge as the ejectors are no longer of high efficiency at higher speeds and the protuberances formed by the ejectors placed on the wing would induce high drag forces, preventing the aircraft from exceeding the 200 knots speeds.

It is therefore advantageous to implement a way to stow these ejectors into the wing, enabling a smoother acceleration with low drag coefficient at higher speeds. In addition, the stowing of ejectors may in effect induce a requirement of large thickness airfoils, capable of housing these ejectors. Since ejectors are also fed via a pneumatic network of pipes and conduits that connect the e.g., a turbo compressor used to compress the air with the said thruster-ejectors. The network is pressurized with the motive air supplied to the thrusters, when in use, and not pressurized when not in use. The volume created thus by the pipes or conduits, which need to be sufficiently large to minimize losses, occupy a large space of a wing. It is desirable to minimize this space in order to allow the use of a thinner airfoil for the wing, conversely allowing for much higher speeds in forward flight.

An embodiment of the invention combines a flexible material used for such conduit 102, which can be made of soft, but reliable, elastic but capable of multiple compressing and extension cycles material such as silicone, with the geometry of a wing 110 and architecture of the Fluidic Propulsive System used on a wing. Namely the wing contains along its span a series of compartments 100 that house such an inflatable material which is connected to the thrusters 101, with openings on the suction side of the wing and said compartment to allow a thruster to be extended, when in use, and retracted into the wing, compressing the unpressurized conduit until the entire body of the thruster is perfectly stowed inside the wing.

In the scenario that the thrusters are to be used, a mechanism 104 extends the thrusters out of the wing while the conduit 102 receives the compressed motive air 111 from a compressor. With motive air 111 rapidly inflating the conduit 102 and thrusters 101 allowing the motive air to flow freely through the primary nozzles, the danger of blockage is minimized. The mechanism to extend the thrusters 101 can also be minimized, as the compressed air helps with this process. The thrusters 101 are connected to the inflatable conduit 102 with known methods of attaching valves 103, e.g., similar to tires from the automotive or truck industry. When fully inflated, the conduit 102 has also design features that allows minimum friction of the flow (so minimum pressure loss) while being able to fill a non-round e.g., rectangularly shaped compartment of the wing, so by avoiding the round shape of a pipe we can minimize the thickness of the airfoil.

The top 105 of the thruster 101 may have panels that can perfectly seal the suction side of the wing, when the thrusters are retracted. When extended, they can be shaped so that a minimum drag results from the configuration.

While retracted, e.g., at 150 knots, using a valve system, the compressed air that acted as motive fluid can be routed directly as a convergent or convergent divergent jet pushing the aircraft forward. With the thrusters retracted, the lift to drag of the aircraft increases significantly, hence minimizing the need for higher horizontal thrust.

In one embodiment, the Lift to Drag coefficient (L/D) of the aircraft 120 increases from 10 to 15 by stowing the thrusters into the wing, so the aircraft requires 1.5 times less thrust to keep the current speed constant. By keeping the level of power (i.e., flow of motive air, expanded as a jet) constant, however, the plane accelerates significantly above 150 knots to up to 300-400 knots depending on the airfoil thickness and wing size. With this approach, forward speeds well exceeding the tilt-rotor or any rotary wing aircraft by 100 knots or more can be achieved. When thrusters are out, a valve forces all air to fill the network of conduits feeding the thrusters, and the high speed nozzle no longer acts (for speeds e.g., less than 150 knots); with the aircraft slowing down while routing the compressed air from the high speed nozzle to feed the thrusters in gradually higher percentage, the aircraft slows down and eventually can operate on thrusters alone, slowing down for Vertical Landing fully on FPS.

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A propulsion system, comprising:
at least one conduit, the conduit configured to carry distribute motive fluid, the conduit further configured to collapse when not supplied with motive fluid from a compressor and inflate when supplied with motive fluid from a compressor; and
at least one ejector in fluid communication with the at least one conduit, wherein the compressor supplies compressed air to the at least one ejector for producing thrust, and wherein the at least one ejector, when not in use, is retractable into a volume of an airfoil streamlining the outside of said airfoil.

2. The system of claim 1 where the airfoil is a component of at least one of a VTOL, STOL or CTOL aircraft.
